(19) United States
(12) Patent Application Publication
(10) Pub. No.: US 2021/0204742 A1
(43) Pub. Date: Jul. 8, 2021

(54) PRESSURE COOKER AND ASSOCIATED METHOD(S)

(71) Applicant: Natarajan AYYAVU, Tamil Nadu (IN)

(72) Inventor: Natarajan AYYAVU, Tamil Nadu (IN)

(21) Appl. No.: 17/056,720

(22) PCT Filed: May 30, 2019
(86) PCT No.: PCT/IN2019/000014

§ 371 Date: Nov. 18, 2020

(30) Foreign Application Priority Data
Jun. 1, 2018 (IN) 201841020568

(51) Int. Cl. A47J 27/08

(52) U.S. Cl. CPC A47J 27/0802; A47J 27/0804

(57) ABSTRACT

A pressure cooker includes a vessel capable of receiving liquid and food product, a gasket positioned along the vessel, a lid removably locked to the vessel to form a pressure-cooking enclosure, and a pressurized-liquid extraction mechanism including a valve coupled to and in fluid communication with one of the lid and the vessel. Upon heating the vessel, an internal vapor pressure level inside the vessel is elevated above an ambient atmospheric pressure level outside the vessel. In this manner, while the internal vapor pressure level inside the vessel is above the ambient atmospheric pressure level outside the vessel, the valve is selectively biased between an open position and a closed position, such that while the valve is at the open position, pressurized-liquid is egressed from the vessel through the valve and discharged exterior of the vessel.

### CROSS REFERENCE TO RELATED APPLICATIONS

This is a US non-provisional patent application and a section 371 US National Phase Entry patent application claiming priority to and the benefit of Patent Cooperation Treaty Application No. PCT/IN2019/000014, filed on May 30, 2019, currently pending, which claims priority to and the benefit of Indian Patent Application No. 201841020568, filed on Jun. 1, 2018, currently pending, all of which are incorporated by reference herein in their entireties.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND

### Technical Field

Exemplary embodiment(s) of the present disclosure relate to pressure cookers and, more particularly, to a pressure cooker configured to allow selective extraction of pressurized liquid from the pressure cooker while a vapor pressure level inside the pressure cooker is above an ambient atmospheric pressure level outside the pressure cooker.

### Prior Art

Conventional pressure cookers typically include a vessel and a lid removably locked with the vessel to create a pressurized cooking vessel. Water is added to the vessel, and heat is supplied to the vessel to cook various food products under a pressurized state within the vessel. The liquid content in the vessel generates vapor when heated and the trapped vapor builds pressure within the cooking enclosure. Thus, the food products are cooked under a vapor pressure level that is greater than an ambient atmospheric pressure level. Further, pressure cookers are generally provided with a pressure regulating mechanism for regulating the vapor pressure to a first predetermined pressure level and a safety pressure relief mechanism to relieve the vapor pressure level to a second predetermined pressure level. Still further, pressure cookers may be provided with a gasket to obtain better sealing between the lid and the vessel.

A by-product of the cooking process is residual liquid that remains within the pressurized vessel. After cooking, usually it is necessary to remove such a liquid from the cooked food. The removed liquid can be, for example, but not limited to: a starch-containing liquid from rice, or a soup from vegetable.

Removing a starch-containing liquid from cooked rice is widely desired for various health benefits. Starch-containing liquid generated from cooked rice is removed from conventional open-top cooking appliances. Consumption of cooked rice after removing starch-containing liquid is found to be beneficial for human health, in particular, for people diagnosed with diabetes, according to medical reports. Unfortunately, starch-containing liquid cannot be removed from rice when the rice is cooked in conventional pressure cookers. Vapor pressure inside a conventional pressure cooker must be gradually lowered to a safe level before the conventional pressure cooker can be opened. This time consumed process causes continued cooking inside the conventional pressure cooker, substantially due to the latent heat of materials present therein. This results in rice being often overcooked and becomes shoddy. This is one of the reasons conventional pressure cookers are not compatible for removing starch-containing liquid therefrom.

Various prior art attempts to remove starch-containing liquid from a pressurized pressure cooker are disclosed in the following Chinese patent references: CN105411378A, CN104970695A, and CN1021289C. Unfortunately, such prior art references include one or more of the following shortcomings: not compatible with a stove; require automation for liquid extraction; require additional components and moving parts; and require an external energy source to facilitate liquid extraction.

In addition, some prior art pressure cookers use gravitational energy in addition to the vapor pressure generated within pressure cookers whereby a communication hole is required in the base portion of the vessel of pressure cookers. Providing communication holes in the base portion is generally not compatible for using pressure cookers on stove top. Some prior art also employs additional equipment that cooperate with pressure cookers to accomplish removal of liquid therefrom. This usually requires programmable cooperation between pressure cookers and the equipment. Such arrangement is usually bulky, inconvenience for use, and expensive.

Accordingly, a need remains for a pressure cooker that can selectively extract liquid under an elevated vapor-pressurized state in order to overcome at least one aforementioned shortcomings. The exemplary embodiment(s) satisfy such a need by providing to a pressure cooker that is convenient and easy to use, lightweight yet durable in design, versatile in its applications, and designed for selectively extracting pressurized liquid from the pressure cooker while a vapor pressure level inside the pressure cooker is above an ambient atmospheric pressure level outside the pressure cooker. Advantages of the pressure cooker include stove compatibility; no automation for liquid extraction; fewer components; and no external energy source for liquid extraction.

### BRIEF SUMMARY OF NON-LIMITING EXEMPLARY EMBODIMENT(S) OF THE PRESENT DISCLOSURE

In view of the foregoing background, it is therefore an object of the non-limiting exemplary embodiment(s) to provide to a pressure cooker configured to allow selective extraction of pressurized liquid from the pressure cooker while a vapor pressure level inside the pressure cooker is above an ambient atmospheric pressure level outside the pressure cooker. Advantages of the pressure cooker include stove compatibility; no automation for liquid extraction; fewer components; and no external energy source for liquid extraction. These and other objects, features, and advantages of the non-limiting exemplary embodiment(s) are provided by a pressure cooker including a portable vessel capable of receiving an existing liquid and an existing food product therein, a lid removably locked to the vessel to form a pressure-cooking enclosure, and a pressurized-liquid extraction mechanism including a valve removably coupled and being in fluid communication with one of the lid and the vessel.

Advantageously, upon heating the vessel, an internal vapor pressure level inside the vessel is elevated above an ambient atmospheric pressure level outside the vessel. In this manner, while the internal vapor pressure level inside the vessel is above the ambient atmospheric pressure level outside the vessel, the valve is selectively biased between an open position and a closed position. Such a structural configuration provides the new, useful, and unexpected results of: while the valve is at the open position, pressurized-liquid is upwardly egressed from the vessel through the valve and discharged exterior of the vessel.

It is another object of the present disclosure to provide a non-limiting exemplary embodiment, wherein a gasket is removably positioned along an outer peripheral edge of the vessel in such a manner that the gasket is continuously intercalated between the vessel and the lid. The valve includes a coupling located at a distal end thereof. The pressurized-liquid extraction mechanism further includes a conduit having a proximal end detachably and fluidly affixed to the coupling of the valve. Such a conduit further has a distal end disposed at a bottom interior surface of the vessel for receiving pressurized-liquid therethrough.

It is another object of the present disclosure to provide a non-limiting exemplary embodiment, wherein the pressurized-liquid extraction mechanism further includes a strainer removably connected to the distal end of the conduit. Such a strainer includes an outer surface having at least one aperture spaced therealong. Advantageously, the at least one aperture is in fluid communication with the distal end of the conduit, such that the pressurized liquid is permitted to ingress the strainer and the conduit while food content is prohibited to ingress the strainer and the conduit.

It is another object of the present disclosure to provide a non-limiting exemplary embodiment, wherein the distal end of the conduit has an arcuate shape and directly engaged with the bottom surface of the vessel.

It is another object of the present disclosure to provide a non-limiting exemplary embodiment, wherein the strainer includes an internal cavity in fluid communication with the distal end of the conduit such that the pressurized liquid that is strained through the at least one aperture is caused to flow through the internal cavity prior to reaching the conduit. In this manner, the distal end of the conduit is encapsulated and housed within the internal cavity of the strainer.

It is another object of the present disclosure to provide a non-limiting exemplary embodiment, wherein the distal end of the valve includes an interior wall including a curvilinear groove extended along an entire circumferential length of the interior wall. Notably, the coupling includes a retainer member dynamically supported at the groove. Advantageously, the proximal end of the conduit includes a neck portion having a width slidably reciprocated, against the retainer member, along an approximately linear vertical travel path registered parallel with a longitudinal axis of the conduit. Such a structural configuration provides the new, useful, and unexpected result of: the neck portion of the conduit being gravitationally displaced downwardly within the valve and along the linear vertical travel path towards the bottom surface of the vessel. Furthermore, the neck portion of the conduit is displaced upwardly within the valve and along the linear vertical travel path away from the bottom surface of the vessel.

It is another object of the present disclosure to provide a non-limiting exemplary embodiment, wherein the at least one aperture is round in shape and suitably sized to prohibit the existing food product from ingressing the conduit.

It is another object of the present disclosure to provide a non-limiting exemplary embodiment, wherein the at least one aperture includes a plurality of apertures juxtaposed side-by-side along a major surface area of the outer surface of the strainer.

It is another object of the present disclosure to provide a non-limiting exemplary embodiment, wherein the distal end of the conduit has a bevelled edge directly engaged with a bottom wall of the interior cavity of the strainer.

It is another object of the present disclosure to provide a method of utilizing a pressure cooker. Such method includes the steps of: providing existing liquid and existing food product; providing a portable vessel; depositing the existing liquid and the existing food product into the portable vessel; providing and removably positioning a gasket along an outer peripheral edge of the vessel; providing a pressurized-liquid extraction mechanism including a valve; removably coupling the valve to the lid such that the valve is in fluid communication with the vessel; and providing and removably locking a lid to the vessel in such a manner that the gasket is continuously intercalated between the vessel and the lid.

The method further includes the steps of: heating the vessel thereby elevating an internal vapor pressure level inside the vessel above an ambient atmospheric pressure level outside the vessel; while the internal vapor pressure level inside the vessel is above the ambient atmospheric pressure level outside the vessel, selectively biasing the valve between an open position and a closed position; and discharging pressurized-liquid exterior of the vessel by upwardly egressing pressurized-liquid from the vessel through the valve while the valve is at the open position. Such method steps provide the new, useful, and unexpected results of: while the valve is at the open position, pressurized-liquid is upwardly egressed from the vessel through the valve and discharged exterior of the vessel.

There has thus been outlined, rather broadly, the more important features of non-limiting exemplary embodiment(s) of the present disclosure so that the following detailed description may be better understood, and that the present contribution to the relevant art(s) may be better appreciated. There are additional features of the non-limiting exemplary embodiment(s) of the present disclosure that will be described hereinafter and which will form the subject matter of the claims appended hereto.

### BRIEF DESCRIPTION OF THE NON-LIMITING EXEMPLARY DRAWINGS

The novel features believed to be characteristic of non-limiting exemplary embodiment(s) of the present disclosure are set forth with particularity in the appended claims. The non-limiting exemplary embodiment(s) of the present disclosure itself, however, both as to its organization and method of operation, together with further objects and advantages thereof, may best be understood by reference to the following description taken in connection with the accompanying drawings in which:

FIG. 1 is a cross-sectional view of a pressure cooker configured to allow selective extraction of pressurized liquid from the pressure cooker while a vapor pressure level inside the pressure cooker is above an ambient atmospheric pressure level outside the pressure cooker, in accordance with a non-limiting exemplary embodiment of the present disclosure;

FIG. 2 is an enlarged cross-sectional view of the pressurized-liquid extraction mechanism shown in FIG. 1;

FIG. 3 is an enlarged view taken along line 3-3 in FIG. 2;

FIG. 3a is an enlarged cross-sectional view taken along line 3a-3a in FIG. 3;

FIG. 4 is a cross-sectional view of a pressure cooker configured to allow selective extraction of pressurized liquid from the pressure cooker while a vapor pressure level inside the pressure cooker is above an ambient atmospheric pressure level outside the pressure cooker, in accordance with another non-limiting exemplary embodiment of the present disclosure wherein the strainer is excluded and its function is integrally provided in the conduit;

FIG. 5 is a cross-sectional view of a pressure cooker configured to allow selective extraction of pressurized liquid from the pressure cooker while a vapor pressure level inside the pressure cooker is above an ambient atmospheric pressure level outside the pressure cooker, in accordance with yet another non-limiting exemplary embodiment of the present disclosure wherein the biasing means is not provided; and

FIG. 6 is a cross-sectional view of a pressure cooker configured to allow selective extraction of pressurized liquid from the pressure cooker when cooking certain food products, for example rice, in accordance with yet another non-limiting exemplary embodiment of the present disclosure wherein the strainer and the conduit are not employed thereby operating similar to a conventional pressure cooker.

Those skilled in the art will appreciate that the figures are not intended to be drawn to any particular scale; nor are the figures intended to illustrate every non-limiting exemplary embodiment(s) of the present disclosure. The present disclosure is not limited to any particular non-limiting exemplary embodiment(s) depicted in the figures nor the shapes, relative sizes or proportions shown in the figures.

### DETAILED DESCRIPTION OF NON-LIMITING EXEMPLARY EMBODIMENT(S) OF THE PRESENT DISCLOSURE

The present disclosure will now be described more fully hereinafter with reference to the accompanying drawings, in which non-limiting exemplary embodiment(s) of the present disclosure is shown. The present disclosure may, however, be embodied in many different forms and should not be construed as limited to the non-limiting exemplary embodiment(s) set forth herein. Rather, such non-limiting exemplary embodiment(s) are provided so that this application will be thorough and complete, and will fully convey the true spirit and scope of the present disclosure to those skilled in the relevant art(s). Like numbers refer to like elements throughout the figures.

The illustrations of the non-limiting exemplary embodiment(s) described herein are intended to provide a general understanding of the structure of the present disclosure. The illustrations are not intended to serve as a complete description of all of the elements and features of the structures, systems and/or methods described herein. Other non-limiting exemplary embodiment(s) may be apparent to those of ordinary skill in the relevant art(s) upon reviewing the disclosure. Other non-limiting exemplary embodiment(s) may be utilized and derived from the disclosure such that structural, logical substitutions and changes may be made without departing from the true spirit and scope of the present disclosure. Additionally, the illustrations are merely representational are to be regarded as illustrative rather than restrictive.

One or more embodiment(s) of the disclosure may be referred to herein, individually and/or collectively, by the term “non-limiting exemplary embodiment(s)” merely for convenience and without intending to voluntarily limit the true spirit and scope of this application to any particular non-limiting exemplary embodiment(s) or inventive concept. Moreover, although specific embodiment(s) have been illustrated and described herein, it should be appreciated that any subsequent arrangement designed to achieve the same or similar purpose may be substituted for the specific embodiment(s) shown. This disclosure is intended to cover any and all subsequent adaptations or variations of other embodiment(s). Combinations of the above embodiment(s), and other embodiment(s) not specifically described herein, will be apparent to those of skill in the relevant art(s) upon reviewing the description.

References in the specification to “one embodiment(s)”, “an embodiment(s)”, “a preferred embodiment(s)”, “an alternative embodiment(s)” and similar phrases mean that a particular feature, structure, or characteristic described in connection with the embodiment(s) is included in at least an embodiment(s) of the non-limiting exemplary embodiment(s). The appearances of the phrase “non-limiting exemplary embodiment” in various places in the specification are not necessarily all meant to refer to the same embodiment(s).

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiment(s) and are not necessarily intended to be construed as limiting.

If used herein, “about” mechanism approximately or nearly and in the context of a numerical value or range set forth mechanism ±15% of the numerical.

If used herein, “substantially” mechanism largely if not wholly that which is specified but so close that the difference is insignificant.

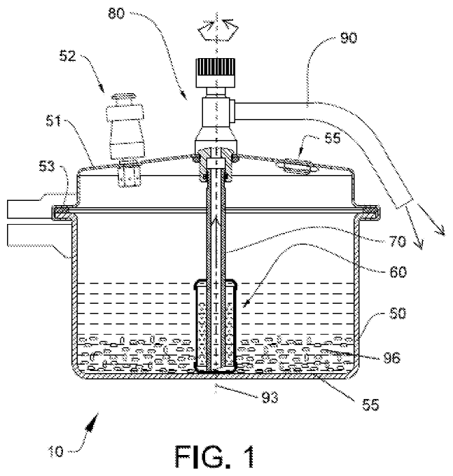

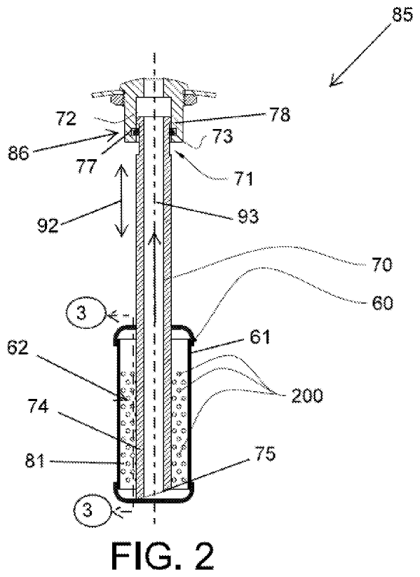

The non-limiting exemplary embodiment(s) is/are referred to generally in FIGS. 1-6 and is/are intended to provide to a pressure cooker 10 configured to allow selective extraction of pressurized liquid from the pressure cooker 10 while a vapor pressure level inside the pressure cooker 10 is above an ambient atmospheric pressure level outside the pressure cooker 10. Advantages of the pressure cooker 10 include stove compatibility; no automation for liquid extraction; fewer components; and no external energy source for liquid extraction. Various non-limiting exemplary embodiments of pressure cooker 10 are identified by reference numerals 10, 12, 14, and 16.

Referring to FIGS. 1-6, the pressure cooker 10 includes a portable vessel 50 capable of receiving an existing liquid and an existing food product therein, a lid 51 removably locked to the vessel 50 to form a pressure-cooking enclosure, and a pressurized-liquid extraction mechanism 85 including a valve 80 removably coupled to and being in fluid communication with one of the lid 51 and the vessel 50. It is noted that valve 80 can be fitted anywhere on the pressure cooker 10 (e.g., side or bottom of either lid 50 or vessel 51). Advantageously, upon heating the vessel 50, an internal vapor pressure level inside the vessel 50 is elevated above an ambient atmospheric pressure level outside the vessel 50. In this manner, while the internal vapor pressure level inside the vessel 50 is above the ambient atmospheric pressure level outside the vessel 50, the valve 80 is selectively biased between an open position and a closed position. Such a structural configuration provides the new, useful, and unexpected results of: while the valve 80 is at the open position, pressurized-liquid is egressed from the vessel 50 through the valve 80 and discharged exterior of the vessel 50. It is noted that the liquid may be egressed along a variety of directions depending on the location of the valve (e.g., egressed horizontally, downwardly, sideways, tangentially, orthogonal to the bottom surface of the vessel 50, obliquely relative to the outer surface of the lid 51, etc.)

In a non-limiting exemplary embodiment, a gasket 53 is removably positioned along an outer peripheral edge of the vessel 50 in such a manner that the gasket 53 is continuously intercalated between the vessel 50 and the lid 51. The valve 80 includes a coupling 86 located at a distal end 74 thereof. The pressurized-liquid extraction mechanism 85 further includes a conduit 70 having a proximal end detachably and fluidly affixed to the coupling 86 of the valve 80. Such a conduit 70 further has a distal end 74 disposed at a bottom interior surface 55 of the vessel 50 for receiving pressurized-liquid therethrough. The pressurized-liquid extraction mechanism 85 further includes a discharge tube 90 for diverting the liquid outside of the vessel 50 and lid 51.

In a non-limiting exemplary embodiment, the pressurized-liquid extraction mechanism 85 further includes a strainer 60 removably connected to the distal end 74 of the conduit 70. Such a strainer 60 includes an outer surface 61 having at least one aperture 200 (perforations) spaced therealong. Advantageously, the at least one aperture 200 is in fluid communication with the distal end 74 of the conduit 70, such that the pressurized liquid is permitted to ingress the strainer 60 and the conduit 70 while food content is prohibited to ingress the strainer 60 and the conduit 70.

In a non-limiting exemplary embodiment, the distal end 74 of the conduit 70 has an arcuate shape and directly engaged with the bottom surface 55 of the vessel 50.

In a non-limiting exemplary embodiment, the strainer 60 includes an internal cavity 62 in fluid communication with the distal end 74 of the conduit 70 such that the pressurized liquid that is strained through the at least one aperture 200 is caused to flow through the internal cavity 62 prior to reaching the conduit 70. In this manner, the distal end 74 of the conduit 70 is encapsulated and housed within the internal cavity 62 of the strainer 60.

In a non-limiting exemplary embodiment, the distal end of the valve 80 includes an interior wall 78 including a curvilinear groove 77 extended along an entire circumferential length of the interior wall 78. Notably, the coupling 86 includes a retainer member 78 dynamically supported at the groove 77. Advantageously, the proximal end of the conduit 70 includes a neck portion 71 having a width slidably reciprocated, against the retainer member 78, along an approximately linear vertical travel path 92 registered parallel with a longitudinal axis 93 of the conduit 70. Such a structural configuration provides the new, useful, and unexpected result of: the neck portion 71 of the conduit 70 being gravitationally displaced downwardly within the valve 80 and along the linear vertical travel path 92 towards the bottom surface 55 of the vessel 50. Furthermore, the neck portion 71 of the conduit 70 is displaced upwardly within the valve 80 and along the linear vertical travel path 92 away from the bottom surface 55 of the vessel 50.

In a non-limiting exemplary embodiment, the at least one aperture 200 are round in shape and suitably sized to prohibit the existing food product 96 from ingressing the conduit 70.

In a non-limiting exemplary embodiment, the at least one aperture 200 includes a plurality of apertures 200 juxtaposed side-by-side along a major surface area of the outer surface 61 of the strainer 60.

In a non-limiting exemplary embodiment, the distal end 74 of the conduit 70 has a bevelled edge 75 directly engaged with a bottom wall of the interior cavity 62 of the strainer 60.

The present disclosure further includes a method of utilizing a pressure cooker 10. Such method includes the steps of: providing existing liquid and existing food product 96; providing a portable vessel 50; depositing the existing liquid and the existing food product 96 into the portable vessel 50; providing a lid 51; providing a pressurized-liquid extraction mechanism 85 including a valve 80; removably coupling and fluidly communicating the valve 80 to one of the lid 51 and the vessel 50; and providing and removably locking the lid 51 to the vessel 50.

The method further includes the steps of: heating the vessel 50 thereby elevating an internal vapor pressure level inside the vessel 50 above an ambient atmospheric pressure level outside the vessel 50; while the internal vapor pressure level inside the vessel 50 is above the ambient atmospheric pressure level outside the vessel 50, selectively biasing the valve 80 between an open position and a closed position; and discharging pressurized-liquid exterior of the vessel 50 by egressing pressurized-liquid from the vessel 50 through the valve 80 while the valve 80 is at the open position. Such method steps provide the new, useful, and unexpected results of: while the valve 80 is at the open position, pressurized-liquid is egressed from the vessel 50 through the valve 80 and discharged exterior of the vessel 50.

Referring to FIG. 1, the pressure cooker 10 includes a vessel 50 and a lid 51. The vessel 50 forms a container to receive food products to be cooked and, in this example, has a circular upper opening and a side wall. The lid 51 has a form for locking the vessel 50 to co-operate therewith and create a cooking enclosure suitable for rising in pressure. The vessel 50 and the lid 51 each can be provided with a handle 56. The pressure cooker can advantageously be provided with a pressure regulating mechanism 52 such as a valve to maintain the internal pressure of the vessel 50 to a first predetermined pressure. The pressure cooker 10 can further be provided with a safety pressure relief valve 55 to relieve the internal pressure of the vessel 50 at a second predetermined pressure. The pressure cooker 10 can advantageously be provided with a gasket 53 between the lid 51 and the vessel 50 for improved sealing therebetween.

It is noted that the non-limiting exemplary embodiment of FIG. 1 is a preferred embodiment that removes nearly all liquid present in the vessel 50 when straining rice and granular food products. It may leave a small amount of liquid when straining vegetable decoction, which is generally acceptable for the users/customers. Advantageously, strainer 60 is easily manufactured and removable for cleaning.

In a non-limiting exemplary embodiment, the pressure cooker 10 further includes a valve 80 removably mounted, in this example, on to the lid 51, and a conduit 70 removably connected to the valve 80. A discharge tube 90 is in fluid communication with the valve 80 for directing pressurized liquid away from the vessel 50 and lid 51. The pressure cooker 10 further includes a strainer member 60 removably connected to the conduit 70 for straining liquid content of the vessel 50. The valve 80 communicates with the pressure cooker 10.

In a non-limiting exemplary embodiment, a strainer member 60 includes a straining section. The straining section provides a plurality of perforations 200 through which liquid within in the vessel 50 can be strained. The perforations 200 are dimensioned such as to only allow liquid to pass through it (e.g., rice cannot pass through the perforations). The perforations 200 all are, generally, of substantially same dimension. The perforations 200 can be formed in number of ways, for example, by mesh screen or formed by operations such as punching.

In a non-limiting exemplary embodiment, strainer member 60 can have any shape of perforations 200. However, a mismatch in shape with food pieces being cooked improves strainer 60 effectiveness. For example, the perforations 200 are round in shape when used for granular food pieces having non-round cross section, for example, rice. Whereas the perforations 200 are of polygonal shape for granular food pieces having round cross sections. The pressure cookers 10 of the present disclosure can use any configuration for the perforations 200 of the strainer member 60. However, the preferred embodiment of the present disclosure presents ways for improving upon effectiveness of the strainer member 60. This is accomplished by: configuring the perforations 200 of the strainer member 60 such that at least certain of the perforations 200 do not allow engagement of the food pieces therewith, thereby net flow area of the perforations 200 can be increased. Net flow area is defined as the area available for fluid flow (considering partial/full blocking of certain perforations 200 by the food pieces being separated) when the strainer member 60 is in use.

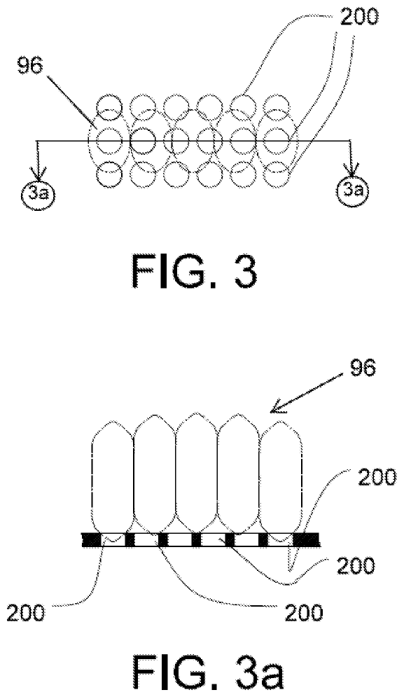

In a non-limiting exemplary embodiment, one way to accomplish the disengagement is to have the pitch of the adjacent perforations 200 dimensioned less than the minimum pitch two rice kernels can form, as shown in FIGS. 3, 3a. Yet another way of achieving the disengagement of food pieces with the perforations 200 is to have a mechanism for keeping away food pieces therefrom, for example a plurality of protruding members are provided on the outer surface of the straining zone. Yet another way of achieving the disengagement is to have the strainer member 60 having a corrugated side wall. A few ways are of accomplishing the disengagement of food pieces with the perforations 200 of the strainer member 60 described as examples.

In a non-limiting exemplary embodiment, since there are a large variety of rice having different shapes and dimensions, the perforations 200 of the strainer member 60 can have diameter from about 0.5 mm to about 1.5 mm, that can be effective to cover a range of rice variation in shape and dimension. This dimension range can be applied for other food items.

FIGS. 3 and 3a illustrate a non-limiting exemplary embodiment of how the strainer efficiency is improved thereby employing less perforations while maintain optimal effectiveness.

In a non-limiting exemplary embodiment, conduit 70 communicates with the valve 80 and the perforations 200 of the straining zone. The distal end of the conduit 70 extends into the liquid present in the vessel 50 for removing the liquid content of the vessel 50. Further the distal end of the conduit 70 can be positioned at the proximal center of the vessel 50 in order to centralize liquid intake.

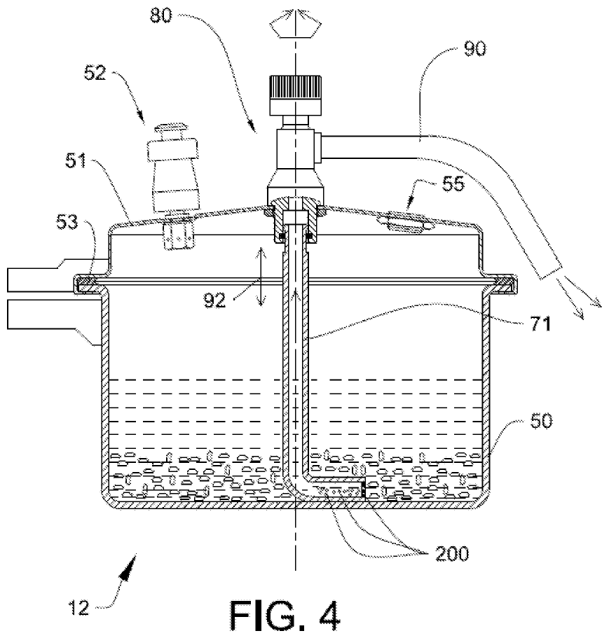

FIG. 4 illustrates a non-limiting exemplary embodiment wherein the strainer 60 is removed and the distal end 74 of conduit 70 is provided with perforations 60 (at least one aperture) thereby further reducing the requisite number of components to extract liquid from the bottom of the vessel 50.

In a non-limiting exemplary embodiment, a closure gap 75 is required between the conduit 70 strainer system and the base of the vessel 50, while the lid 51 closes the vessel 50. For example: when a gasket is used in between the vessel 50 and the lid 51, the gasket gets compressed a little to obtain better sealing therebetween; and/or food particles can come in the way between the conduit 70 strainer system and the base of the vessel 50. Generally, when straining granular food items, for example rice, the closure gap 75 can be present and can still achieve nearly complete removal of liquid due to the presence of the interconnected porosity in the granular heap leading to the distal end of the conduit 70. However, the gap 75 shall be as minimum as possible in order to reduce starch sediments on food pieces being cooked. Hence, it is generally better to reduce/avoid this gap 75.

In a non-limiting exemplary embodiment, in order to reduce/eliminate the need of this closure gap 75, the pressure cooker is provided with a mechanism for biasing the conduit 70 strainer system towards the base of the vessel 50. Retractable nature of the biasing mechanism allows the compression of the gasket while closing the lid 51 to the vessel 50. Even there exists the gap 75 between the conduit 70 strainer member 60 system and the base (bottom surface) of the vessel 50 due to the presence of the food pieces in between, as the cooking goes on, the biasing mechanism can bias the conduit 70 strainer to the base of the vessel 50 due to movement of the content of the vessel 50. The biasing mechanism can be, for example, a gravity type biasing mechanism for sliding the conduit 70 towards the base of the vessel 50, a spring biasing the conduit 70 substantially in its axis, or a flexible conduit 70.

In a non-limiting exemplary embodiment, as shown in FIG. 1, the biasing mechanism are of gravity type wherein the biasing mechanism bias, by gravity, the conduit 70 such that the distal end thereof touches the base of the vessel 50. The biasing mechanism of the preferred embodiment of the present invention, includes a neck portion 71 integrally provided on the outer side of the conduit 70, and a connection hole 72 having a retainer element 73, wherein the connection hole 72 is provided in the connection section of the valve 80. The neck portion 71 is a slender portion between two portions of the conduit 70. The connection hole 72 receives a portion of the conduit 70, including the neck portion 71, and the retainer element 73 engages with the neck portion 71 of the conduit 70 so as to allow a sliding movement of the conduit 70 towards/away from the base of the vessel 50. The amount of sliding movement is generally more than the closure gap 75 required by the pressure cooker. The closure gap 75 can be kept generally about 10 mm. To remove the conduit 70 from the valve 80, the retainer element 73 is disengaged from the neck portion 71 and the conduit 70 is removed off the connection section of the valve 80. The retainer element 73 can be, for example, a split ring, detent, a screw, etc.

In a non-limiting exemplary embodiment, the vapor pressure generated within the pressure cooker 10,12,14 is used as propellant for removing the liquid content of the pressure cooker 10,12,14. Generally, the pressure cooker 10 can be built for one bar gauge pressure (i.e. one bar pressure above the ambient atmospheric pressure) as certain known pressure cookers are built. Practical experience has shown that vapor pressure less than one bar gauge pressure is sufficient for removing the liquid content therefrom for a variety of recipes. The liquid content removal can be continued as long as the pressure cooker 10,12,14 has vapor pressure therein. Generally, pressure cookers are built for maintaining a nominal cooking pressure up to 1 kgf/cm2 gauge nominal (approximately equivalent to 1 bar gauge pressure), and certain pressure cookers are built for more pressure. Usually, the liquid removal is performed after switching off heat input, and often after an idle time to obtain a desired rice texture. By this time, the pressure cooker loses some amount of its pressure generally due to the vapor leak through the pressure regulator. Advantageously, we observed that even at such reduced pressure due to aforementioned reasons, the pressure cooker can remove all/nearly all liquid content.

In a non-limiting exemplary embodiment, when cooking white rice in a known pressure cooker, about two parts of cooking liquid for every one part of white rice is added to the known pressure cooker so that no liquid is left therein after cooking. Whereas, excess cooking liquid is added in the pressure cooker 10 of the present invention when liquid removal is desired. For example, cooking liquid to white rice ratio of 3:1 can be used, whereby certain amount of liquid is left at the base of the vessel 50 for removal. After cooking with excess cooking liquid, when the user desires to remove the liquid content of the vessel 50, he/she operates the valve 80 to the open position and the liquid content moves upwardly through the valve 80 via the perforations 200 and the conduit 70, wherein the liquid content of the vessel 50 can be removed as long as the vessel 50 has vapor pressure. As a result, solid content (e.g., rice) is left in the vessel 50.

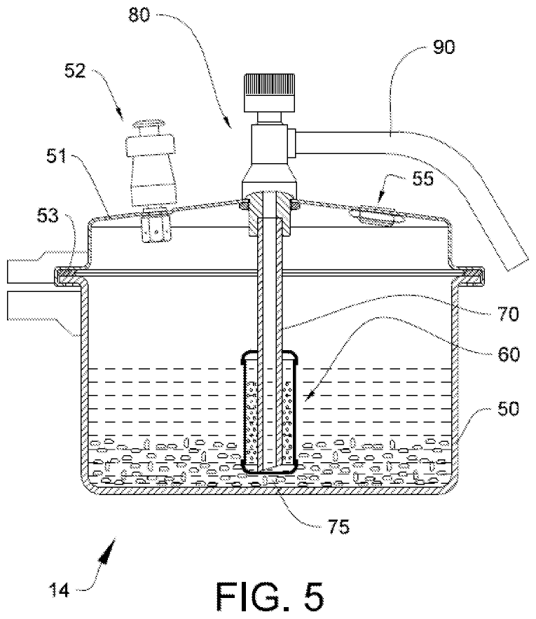

In a non-limiting exemplary embodiment, nearly complete removal of liquid content from pressure cooker 10 is desired in certain food items. In a non-limiting exemplary embodiment, shown in FIG. 4, the conduit 70 of the pressure cooker 10 is in contact with the base of the vessel 50 for removing nearly all the liquid content of the vessel 50. A distal end of the conduit 70 touches the base (e.g., bottom surface) of the vessel 50, and has an L-shaped profile so that the end part of the conduit 70 extends along the base of the vessel 50. The straining zone is integrally provided in the conduit 70, so strainer member 60 is excluded. Nearly all the liquid content can be removed from the vessel 50 using this pressure cooker 10; only a small amount of liquid content is left at the base of the vessel 50. Like parts to the pressure cooker 10 of FIG. 1 and FIG. 5 have been given the same reference numerals and will not be described again. Operation of the pressure cooker 10 of FIG. 4 is the same as for FIGS. 1 and 5, and again will not be described.

In a non-limiting exemplary embodiment, shown in FIG. 5, the pressure cooker 10 excludes the biasing mechanism. Such an embodiment is effective in straining rice but may not be suitable for decoction of vegetables, etc. for complete removal of liquid. The valve 80 is removably connected to the conduit 70. A gap 75 is maintained between the conduit 70 strainer member 60 system and the base of the pressure cooker 10 for the aforementioned reasons. The pressure cooker 10 in this arrangement leaves a predetermined amount of liquid at the base thereof, after completion of the discharge, which can be useful for hydrating the solid content of the vessel 50 to obtain desired texture or hardness of the solid content. Further, the pressure cooker 10 has a fewer number of moving parts. Like parts to the pressure cooker 10 of FIG. 1 and FIG. 5 have been given the same reference numerals and will not be described again. Operation of the pressure cooker 10 of FIG. 5 is the same as FIG. 1 and again will not be described.

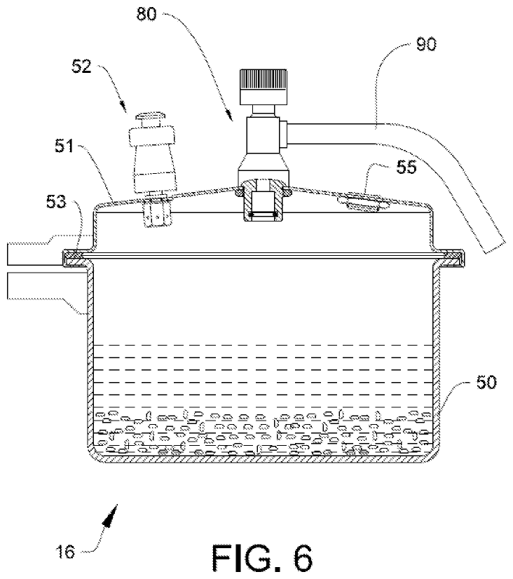

In a non-limiting exemplary embodiment 16, shown in FIG. 6, the pressure cooker 10 is a modification of embodiments 10 and 12 wherein the conduit 70 strainer member 60 system is excluded thereby operating like a conventional pressure cooker. Such a non-limiting exemplary embodiment 16 removes liquid from rice when cooking quantity is small, but still starch particles can be seen. The embodiment 16 is not effective for vegetable decoction. After cooking, when the pressure cooker 10 has vapor pressure therein, the valve 80 is operated to open thereby the fluid content of the pressure cooker 10, gets removed therefrom. While cooking food item that foam when boiling, for example rice, the pressure cooker 10 according to FIG. 6 may leave a small amount of liquid at the base of the vessel 50 after completion of the removal of the liquid content. However, when cooking food item that is non-foaming during boiling, the liquid removal is not effective. The pressure cooker 10 has a fewer number of moving parts. Like parts to the pressure cookers 10 of FIG. 1, FIG. 4, FIG. 5, and FIG. 6 have been given the same reference numerals and will not be described again. The pressure cooker 10 according to FIG. 6 may be used for pressure cooking without liquid removal or used for liquid removal for certain recipes.

In a non-limiting exemplary embodiment, the base portion of any pressure cooker 10 of all of the described embodiments of the present invention lack of holes or devices that interfere with heat source of stoves. Thereby, the pressure cookers 10 of the present invention are compatible to stove top, for example to a gas stove. The pressure cookers 10 of the present invention use the vapor pressure generated within. However, gaseous propellants from external sources may be used instead.

While non-limiting exemplary embodiment(s) has/have been described with respect to certain specific embodiment(s), it will be appreciated that many modifications and changes may be made by those of ordinary skill in the relevant art(s) without departing from the true spirit and scope of the present disclosure. It is intended, therefore, by the appended claims to cover all such modifications and changes that fall within the true spirit and scope of the present disclosure. In particular, with respect to the above description, it is to be realized that the optimum dimensional relationships for the parts of the non-limiting exemplary embodiment(s) may include variations in size, materials, shape, form, function and manner of operation.

The Abstract of the Disclosure is provided to comply with 37 C.F.R. § 1.72(b) and is submitted with the understanding that it will not be used to interpret or limit the scope or meaning of the claims. In addition, in the above Detailed Description, various features may have been grouped together or described in a single embodiment for the purpose of streamlining the disclosure. This disclosure is not to be interpreted as reflecting an intention that the claimed embodiment(s) require more features than are expressly recited in each claim. Rather, as the following claims reflect, inventive subject matter may be directed to less than all of the features of any of the disclosed non-limiting exemplary embodiment(s). Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiment(s) which fall within the true spirit and scope of the present disclosure. Thus, to the maximum extent allowed by law, the scope of the present disclosure is to be determined by the broadest permissible interpretation of the following claims and their equivalents, and shall not be restricted or limited by the above detailed description.

What is claimed as new and what is desired to secure by Letters Patent of the United States is:

1. A pressure cooker comprising:
a vessel capable of receiving an existing liquid and an existing food product therein;
a lid removably locked to said vessel to form a pressure-cooking enclosure; and
a pressurized-liquid extraction mechanism comprising a valve coupled to and in fluid communication with one of said lid and said vessel;
wherein, upon heating said vessel, an internal vapor pressure level inside said vessel is elevated above an ambient atmospheric pressure level outside said vessel;
wherein, while the internal vapor pressure level inside said vessel is above the ambient atmospheric pressure level outside said vessel, said valve is selectively biased between an open position and a closed position;
wherein, while said valve is at said open position, pressurized liquid is egressed from said vessel through said valve and discharged exterior of said vessel.

2. The pressure cooker of claim 1, further comprising:
a gasket positioned along an outer peripheral edge of said vessel and continuously intercalated between said vessel and said lid;
wherein said valve comprises: a coupling located at a distal end thereof, wherein said pressurized-liquid extraction mechanism further comprises a conduit having a proximal end detachably and fluidly affixed to said coupling of said valve, said conduit further having a distal end disposed at a bottom interior surface of said vessel for receiving pressurized-liquid therethrough.

3. The pressure cooker of claim 2, wherein said pressurized-liquid extraction mechanism further comprises:
a strainer removably connected to said distal end of said conduit, said strainer including an outer surface having at least one aperture, wherein said at least one aperture are in fluid communication with said distal end of said conduit;
wherein said pressurized liquid is permitted to ingress said strainer and said conduit while food content is prohibited to ingress said strainer and said conduit.

4. The pressure cooker of claim 3, wherein said distal end of said conduit has an arcuate shape and directly engaged with said bottom surface of said vessel.

5. The pressure cooker of claim 4, wherein said strainer comprises: an internal cavity in fluid communication with said distal end of said conduit such that said pressurized liquid that is strained through said at least one aperture is caused to flow through said internal cavity prior to reaching said conduit;
wherein said distal end of said conduit is encapsulated and housed within said internal cavity of said strainer.

6. The pressure cooker of claim 5, wherein said distal end of said valve comprises: an interior wall including a curvilinear groove extended along an entire circumferential length of said interior wall;
wherein said coupling comprises a retainer member disposed at said groove;
wherein said proximal end of said conduit comprises a neck portion having a width slidably reciprocated, against said retainer member, along an approximately linear vertical travel path registered parallel with a longitudinal axis of said conduit;
wherein said neck portion of said conduit is gravitationally displaced downwardly within said valve and along the linear vertical travel path towards said bottom surface of said vessel;
wherein said neck portion of said conduit is displaced upwardly within said valve and along the linear vertical travel path away from said bottom surface of said vessel.

7. The pressure cooker of claim 6, wherein said at least one aperture is round in shape and suitably sized to prohibit the existing food product from ingressing said conduit.

8. The pressure cooker of claim 7, wherein said at least one aperture comprises: a plurality of apertures juxtaposed side-by-side along a major surface area of said outer surface of said strainer.

9. The pressure cooker of claim 8, wherein said distal end of said conduit has a bevelled edge directly engaged with a bottom wall of said interior cavity of said strainer.

10. A pressure cooker comprising:
a portable vessel capable of receiving an existing liquid and an existing food product therein;
a lid removably locked to said vessel to form a pressure-cooking enclosure; and
a pressurized-liquid extraction mechanism comprising a valve coupled to and in fluid communication with one of said lid and said vessel;
wherein, upon heating said vessel, an internal vapor pressure level inside said vessel is elevated above an ambient atmospheric pressure level outside said vessel;
wherein, while the internal vapor pressure level inside said vessel is above the ambient atmospheric pressure level outside said vessel, said valve is selectively biased between an open position and a closed position;
wherein, while said valve is at said open position, pressurized liquid is egressed from said vessel through said valve and discharged exterior of said vessel.

11. The pressure cooker of claim 10, further comprising:
a gasket positioned along an outer peripheral edge of said vessel and continuously intercalated between said vessel and said lid;
wherein said valve comprises: a coupling located at a distal end thereof, wherein said pressurized-liquid extraction mechanism further comprises a conduit having a proximal end detachably and fluidly affixed to said coupling of said valve, said conduit further having a distal end disposed at a bottom interior surface of said vessel for receiving pressurized-liquid therethrough.

12. The pressure cooker of claim 11, wherein said pressurized-liquid extraction mechanism further comprises:
a strainer removably connected to said distal end of said conduit, said strainer including an outer surface having at least one aperture spaced therealong, wherein said at least one aperture are in fluid communication with said distal end of said conduit;
wherein said pressurized liquid is permitted to ingress said strainer and said conduit while food content is prohibited to ingress said strainer and said conduit.

13. The pressure cooker of claim 12, wherein said distal end of said conduit has an arcuate shape and directly engaged with said bottom surface of said vessel.

14. The pressure cooker of claim 13, wherein said strainer comprises: an internal cavity in fluid communication with said distal end of said conduit such that said pressurized liquid that is strained through said at least one aperture is caused to flow through said internal cavity prior to reaching said conduit;
wherein said distal end of said conduit is encapsulated and housed within said internal cavity of said strainer.

15. The pressure cooker of claim 14, wherein said distal end of said valve comprises: an interior wall including a curvilinear groove extended along an entire circumferential length of said interior wall;
wherein said coupling comprises a retainer member disposed at said groove;
wherein said proximal end of said conduit comprises a-neck portion having a width slidably reciprocated, against said retainer member, along an approximately linear vertical travel path registered parallel with a longitudinal axis of said conduit;
wherein said neck portion of said conduit is gravitationally displaced downwardly within said valve and along the linear vertical travel path towards said bottom surface of said vessel;
wherein said neck portion of said conduit is displaced upwardly within said valve and along the linear vertical travel path away from said bottom surface of said vessel.

16. The pressure cooker of claim 15, wherein said at least one aperture are round in shape and suitably sized to prohibit the existing food product from ingressing said conduit.

17. The pressure cooker of claim 16, wherein said at least one aperture comprises: a plurality of apertures juxtaposed side-by-side along a major surface area of said outer surface of said strainer.

18. The pressure cooker of claim 17, wherein said distal end of said conduit has a bevelled edge directly engaged with a bottom wall of said interior cavity of said strainer.

19. A method of utilizing a pressure cooker, said method comprising the steps of:
providing existing liquid and existing food product;
providing a portable vessel;
depositing the existing liquid and the existing food product into said portable vessel;
providing a lid;
providing a pressurized-liquid extraction mechanism including a valve;
removably coupling and fluidly communicating said valve to one of said lid and said vessel;
removably locking said lid to said vessel;
heating said vessel thereby elevating an internal vapor pressure level inside said vessel above an ambient atmospheric pressure level outside said vessel;
while the internal vapor pressure level inside said vessel is above the ambient atmospheric pressure level outside said vessel, selectively biasing said valve between an open position and a closed position; and
discharging pressurized-liquid exterior of said vessel by egressing pressurized-liquid from said vessel through said valve while said valve is at said open position.
